(19) United States
(12) Patent Application Publication
(10) Pub. No.: US 2008/0121171 A1
(43) Pub. Date: May 29, 2008

(54) TEMPERATURE SENSITIVE COLOR CHANGING CABLE APPARATUS

(76) Inventor: James HULSEY, Canton, GA (US)

Correspondence Address: Muncy, Geissler, Olds & Lowe, PLLC, P.O. BOX 1364, FAIRFAX, VA, 22038-1364, US

(21) Appl. No.: 11/564,283

(22) Filed: Nov. 28, 2006

(51) Int. Cl. G01K 3/00; F16L 3/08

(52) U.S. Cl. 116/216; 248/49

(57) ABSTRACT

A communication cable apparatus, such as an actual cable, a connector for a cable end, a jacks for receiving a cable connector, or a holder or tie for bundling cables, includes at least one component formed of a material which can change color. The color change is visible to a human observer and is indicative of a temperature of the component. One or more colors changes may occur to indicate one or more ranges of temperature.

### BACKGROUND OF THE INVENTION

1. Field of the Invention

The present invention relates to cable apparatus, such as actual cables, holders or ties for bundling cables, connectors for cable ends, and jacks for receiving cable connectors. More particularly, the present invention relates a component part of a cable apparatus, which includes a color changing material that changes visible color in response to a temperature change.

2. Description of the Related Art

Materials which change color in response to a temperature increase and/or decrease are well known in the art (See for example, U.S. Pat. Nos. 4,743,398, 5,135,795, 5,281,570, 5,340,537, 6,494,950 and 6,706,218 and U.S. Published Application 2003/0224917). Such materials are often employed in toys or novelty items, such as mood rings, beverage containers (to change a picture printed on the side of the container in response to a hot or cold liquid being inside the container), children's books (to reveal a secret word or picture by heating the existing picture), etc. There are many examples where the function of such materials that change color in response to temperature have been employed in useful articles.

For example, such color changing materials have been employed in devices to monitor the temperature of the human body, such as disposable thermometers and a baby's pacifier (U.S. Pat. Nos. 4,154,106, 4,397,570 and 5,176,704). Such materials have been combined with a food container to monitor the temperature of the food therein (U.S. Pat. No. 4,919,983). Such color changing materials have been used to form a pipe to indicate the temperature of a fluid flow through the pipe (U.S. Pat. No. 5,415,203). Such materials have also been used in several other miscellaneous articles, such as hair curlers (U.S. Pat. No. 5,606,983), fishing lures (U.S. Pat. No. 5,222,320), artificial finger nails (U.S. Pat. No. 4,920,991), candles (U.S. Pat. No. 6,200,129) and umbrellas (U.S. Pat. No. 6,196,241).

Also, such color changing materials have been employed to monitor the condition of the charged state of batteries. See U.S. Pat. Nos. 5,491,420 and 5,557,208, where a resistive circuit on the casing of a battery heats up in relation to a charge within the battery. The heat of the circuit causes a color change on the battery casing indicating to the user the battery's charged status. Also, such color changing materials have been used to monitor the temperature of discrete components (e.g. resistors and capacitors) and integrated circuit chips on a printed circuit board (U.S. Pat. No. 4,891,250).

Earlier color monitoring systems are also known, wherein a material is selected to permanently change color to indicate a failure or imminent failure of a product. For example, U.S. Pat. No. 4,471,711 discloses a push-pull cable of the type used to impart mechanical movement to brakes, clutches, throttles and the like, which includes a green nylon conduit portion. The conduit portion includes an additive which causes the conduit to turn dark brown after being exposed to 2,000 hours of 300 degree Fahrenheit heat, which indicates to a repairman that failure is imminent.

As evidenced above, materials, which change visible color in response to a temperature change are known in the art, and one of ordinary skill in the art can make reference to the Patent literature mentioned above, which is hereby incorporated by reference, to learn the details of such material compositions. To the best of Applicant's knowledge such color changing materials have never been employed in the cabling art, nor has there been any appreciation of a need to employ such materials in the cabling art.

### SUMMARY OF THE INVENTION

The Applicant has appreciated a need in the art of communication transmitting devices, and in particular cabling apparatus such as cables, connectors for cable ends, jacks for connectors and cable guides or ties. More particularly, the Applicant has appreciated a need in the art for gaining a quick sense of the temperature of such cabling devices.

Typical networking closets in office buildings become extremely warm. Older buildings were not designed with HVAC systems suitable for networking closets. Also, as technology advances, more and more electronic equipment, such as multiple servers, memory backups, backup power supplies and patch panels, are being crowded into the network closets of office buildings. A common quick fix is to place a portable air conditioner in the floor of the network closet and direct its cooling air output stream at the hottest area or the area with equipment most sensitive to heat.

The Applicant has also appreciated that the recent popularity of power-over-Ethernet equipment, such as network telephones, has exacerbated the problem. Now, more and/or larger power supplies are required in the network closet, and communication cables and connectors, which previously carried mostly data or low level voltages, are carrying power to power peripheral devices and hence become additional potential heat sources.

In studying the network closet layout, the Applicant has appreciated that cables, cable connectors, jacks, cable guides and cable ties are prevalent through the network closet space. Cables usually span along the ceilings and side walls, lie alongside equipment in bundles held together by ties and guides, terminate with connectors connected to jacks mounted in connector blocks or faceplates of patch panels, servers, etc.

As such cabling devices are located throughout the network closet, the Applicant has invented a cabling device which includes at least one component part formed of a material that changes visual color in response to a temperature change. By such an arrangement, the technician in charge of the network closet can quickly, visually assess the temperature status of various areas within the network closet. Hot areas will be quite evident by virtue of the difference in color in the particular area.

For example, if normally black cabling which is located throughout the network closet transitions to a green and then yellow color in a back ceiling corner of the networking closet, the technician can take action, such as by directing the output of the portable air condition in that direction and investigating the source of the excessive heat. As another example, if one jack in a patch panel for an Ethernet system is yellow while the remaining jacks are green colored, the technician can investigate the issue and look for a short or overload on the power-over-Ethernet connection leading to the yellow jack.

Therefore, it is an object of the invention to provide a quick system and method of assessing temperature, in various locations where communication equipment is in use, by visual inspection without requiring the expense or space associated with placing numerous dedicated thermometers or thermometer probes about the location.

It is another object of the invention to provide a humanly perceptible temperature tracking system and method which does not require a technician to physically touch a cable, a cable connector or a jack to determine if such device is overheated.

It is yet another object of the invention to provide a system and method which provides a rough estimation of the temperature of a communication connecting device, such as a cable, a cable connector or a jack, based upon a color of the communication connecting device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a coaxial cable in accordance with the present invention;

FIG. 1A is a cross sectional view of a coaxial cable in accordance with a second embodiment of the present invention;

FIG. 2 is a perspective view of a twisted pair cable in accordance with the present invention;

FIG. 3 is a perspective view of a fiber optic cable in accordance with the present invention;

FIG. 4 is a cross section view of a plurality of cables being held by a cable tie in accordance with the present invention;

FIG. 5 is a perspective view of a cable wrap in accordance with the present invention;

FIG. 6 is a perspective view of an F-type connector for a coaxial cable in accordance with the present invention;

FIG. 7 is a perspective view of an RCA-type connector for a coaxial cable in accordance with the present invention;

FIG. 8 is a perspective view of an RJ-type plug of a twisted pair cable in accordance with the present invention;

FIG. 9 is a perspective view of a fiber optic connector of a fiber optic cable in accordance with the present invention;

FIG. 10 is a perspective view of an RJ-type jack in accordance with the present invention;

FIG. 11 is a perspective view of a connector block for a twisted pair cable in accordance with the present invention; and

FIG. 12 is a perspective view of a faceplate of a jack in accordance with the present invention.

### DETAILED DESCRIPTION OF A PREFERRED EMBODIMENT

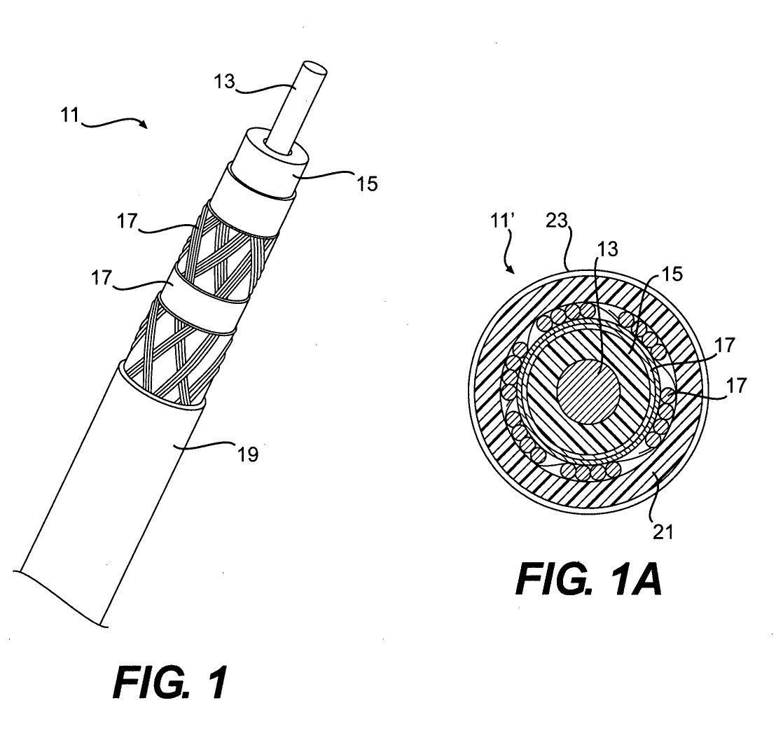

FIG. 1 illustrates a coaxial cable 11 in accordance with the present invention. The coaxial cable 11 is capable of transmitting high speed digital or analog data signals. The coaxial cable 11 includes a center conductor 13 surrounded by a dielectric 15 and one or more shielding layers 17. Finally, a jacket 19 surrounds the shielding layers 17.

The jacket 19 is formed mainly of flame-retardant polyvinylchloride (PVC), polyethylene, polyvinylidene fluoride (PVDF), or a similar material. However, in accordance with the present invention, the jacket 19 also includes an additive or outer layer, which causes the jacket 19 to change color in response to temperature. An additive, such as a leuco dye (LD), may be added to the jacket material composition at a percentage level designed to cause the jacket 19 to change color at a designated threshold temperature, such as 90 degrees Fahrenheit. Of course the threshold temperature could be set at other values, such as 100 degrees, 110 degrees or 120 degrees Fahrenheit.

A leuco dye additive, which can be designed to present a color change at a threshold temperature, is generally known in the art. See for example, the products sold by the Color Change Corporation of Streamwood, Ill. advertising at www.colorchange.com which sells such LD additives. Also, thermochromic polymers are known in the art and can be incorporated into commercially available paints, plastics, and rubbers at approximately 0.1-1.0% by weight in the host polymer to provide a reversible thermochromic color transition in response to a change in temperature. See for example, the research conducted by professors Brett Lucht, Bill Euler and Otto Gregory at the University of Rhode Island, as discussed in more detail at: http://bilbo.chm.uri.edu/SST/thermochromic.html. Moreover, other types of materials and additives which change color in response to temperature are also known in the art, and were incorporated by reference in the listed U.S. patents mentioned in the background section of the application.

The color changing additive would be incorporated into the material used to extrude the jacket 19 of the coaxial cable 11 at a percentage by weight to induce a color change at a desired temperature threshold. For example, the material's color could remain a constant color (e.g., black) below the threshold temperature, but change colors above the threshold temperature (e.g., from black to green to red to yellow), as the temperature increases. Alternatively, the material's color could remain a constant color (e.g., black) below the threshold temperature, and change to a constant color (e.g., yellow) at temperatures above the threshold temperature.

The temperature threshold could be set based upon the customer's needs, such that if the cable were to be connected to equipment which had a normal operating temperature not to be exceeded, the cable jacket 19 could have its temperature threshold set such that the cable jacket 19 changed colors when the temperature of the cable jacket approached the upper limits of the normal operating temperature of the equipment. In this regard, several different models of coaxial cable could be manufactured, each with a unique temperature threshold setting. The cables could be labeled and marketed based upon the threshold temperature where a color change occurs, such that the customer could choose the cable best suited for the end use.

FIG. 1A is a cross sectional view of a coaxial cable 11′ in accordance with a second embodiment of the present invention. FIG. 1A illustrates that the color changing material may be formed as a layer 23 on the outer surface of a typical jacket 21. The typical jacket 21 would not include the color changing material as an additive. The layer 23 may be subsequently applied to an extruded typical jacket 21 during or after manufacturing of the coaxial cable 11′. If the color changing material 23 is applied as a layer, then more precise color changing liquid crystals may be employed as the color changing material. Liquid crystals, such as those sold by the Color Change Corporation referenced above, exhibit a black color below a temperature range's lower threshold, go through the colors of the spectrum as the liquid crystal progresses through the temperature range and then exhibit a black color above the temperature range's higher threshold. The temperature range of the liquid crystal can be formulated to reside within temperatures of −25 to +250° F., and the liquid crystal can be sensitive enough to detect temperature changes as small as 0.2° F.

It is also possible for a coaxial cable 11″ to have both the layer 23 and coloring changing jacket 19, so that the coaxial cable 11″ could exhibit three distinct colors to represent a plurality of temperature ranges. For example, the layer 23 could have two states for two temperature ranges, such as a black color when the layer 23 is not translucent at cool temperatures (e.g. below 75 degrees Fahrenheit) and the layer 23 could become translucent to show a color of the underlying jacket 19 at temperatures above 75 degrees Fahrenheit. The underlying jacket 19 could be designed to remain green at temperatures below 95 degrees Fahrenheit and to turn yellow at temperatures above 95 degrees Fahrenheit. Then, the overall cable 11″ would exhibit three different colors, dependent upon the temperature of the cable 11″. In this example, the cable 11″ would appear black at temperatures below about 75 degrees Fahrenheit, green at temperatures between about 75 degrees and 95 degrees Fahrenheit, and yellow at temperatures above about 95 degrees Fahrenheit.

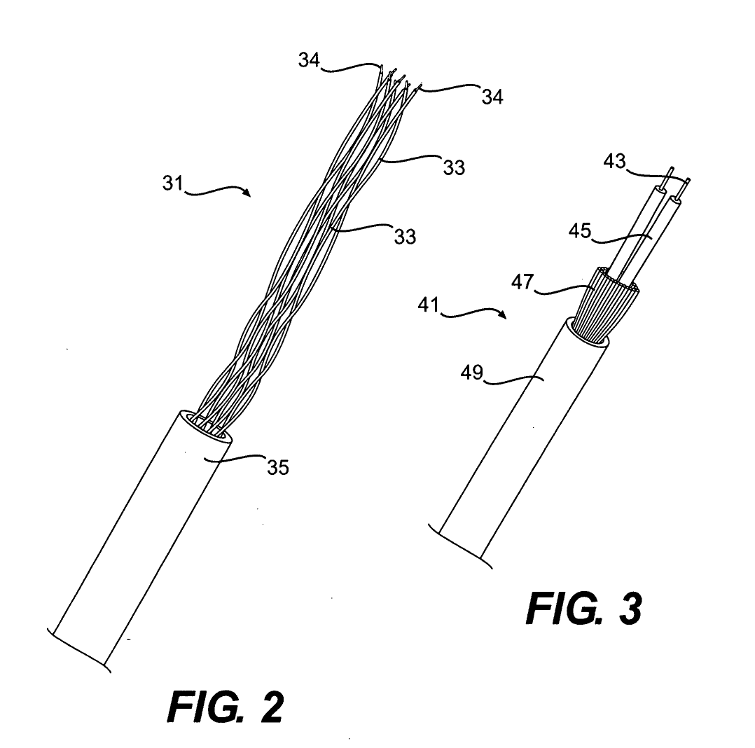

FIG. 2 illustrates a twisted pair cable 31 in accordance with the present invention. The twisted pair cable 31 is capable of transmitting high speed digital or analog data signals. The twisted pair cable 31 includes a plurality of twisted pairs 33 of insulated conductors 34. Four twisted pairs 33 are illustrated, however more or less twisted pairs 33 could be included. Finally, a jacket 35 surrounds and protects the twisted pairs 33.

As with the coaxial cable 11, 11′, 11″ discussed above, the present invention has an inventive jacket 35, which exhibits color changes in response to temperature changes, which temperature changes may be the result of ambient air temperature surrounding the jacket 35 and/or may be due to communications and power transmissions occurring on the conductors 34. The conductors 34, if transmitting power (such as with power-over-Ethernet situations) can generate heat. Also, electrical conductors 13 and 34 are good thermal conductors. Therefore, if the cable 11 or 31 is connected to a jack of a piece of equipment that generates heat, heat from the equipment will travel through the jack and into the conductor 13 or 34 of the cable 11 or 31. Evidence of an overheating piece of equipment can be seen by a color change in the cable 11 or 31 proximate the connection of the cable 11 or 31 to the piece of equipment.

As with the coaxial cable 11, 11′, 11″, the twisted pair cable 31 may have a jacket 35 including color changing materials as an additive and/or as a layer. Moreover, the jacket 35 may exhibit more than one color change to represent ranges of temperatures.

FIG. 3 illustrates a fiber optic cable 41 in accordance with the present invention. The fiber optic cable 41 is capable of transmitting high speed digital or analog data signals. The fiber optic cable 41 includes one or more optical fibers 43, each surrounded by a buffer 45. A plurality of protection fibers 47, such as aramid yarn, mechanically protect the optical fibers 43 and provide stain relief at a termination of the fiber optic cable 41. Finally, a jacket 49 surrounds and protects the protection fibers 47 and the optical fibers 43 surrounded by buffers 45.

As with the coaxial cable 11, 11′, 11″ and the twisted pair cable 31 discussed above, the present invention has an inventive jacket 49, which exhibits color changes in response to temperature changes. The jacket 49 may include the color changing materials as an additive and/or as an outer layer. Moreover, the jacket 49 may exhibit more than one color change to represent ranges of temperatures.

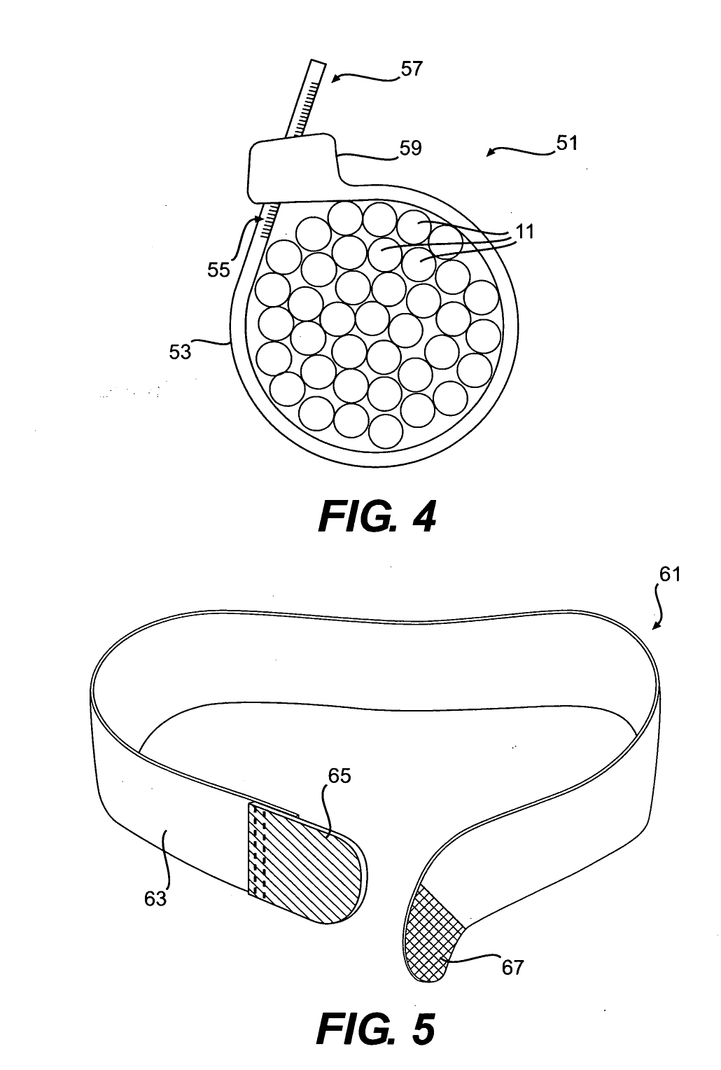

FIG. 4 illustrates a cable apparatus in the form of a cable tie 51. In FIG. 4, the cable tie 51 is surrounding a bundle of coaxial cables 11. However, it should be appreciated that such a cable tie 51 could instead, or in addition, surround twisted pair cables 31 and/or fiber optic cables 41. The cable tie 51 is a generally flat and flexible plastic strap 53 having grooves or ribs 55 along a portion adjacent a first end 57 of the strap 53. A connection head 59 is located proximate an opposite, second end of the strap 53. The connection head 59 includes a through-slot with a cooperative locking structure to engage the grooves or ribs 55 in a well known manner, such that said plastic strap 53 may be wrapped around cables 11 to bundle the wrapped cables 11. More details concerning such a cable tie 51 can be seen in U.S. Pat. No. 3,965,538, which is hereby incorporated by reference.

The plastic material forming the cable tie 51 includes a material which exhibits color changes in response to temperature changes. The color changing material may be an additive to the plastic material forming the cable tie 51 and/or the color changing material may be formed as a layer over all of, or a portion of, the cable tie 51. Moreover, the cable tie 51 may exhibit more than one color change to represent ranges of temperatures and may employ both a color changing material layer and a color changing material additive, as discussed above in conjunction with the cable jackets.

FIG. 5 illustrates a cable apparatus in the form of a cable wrap 61. The cable wrap 61 is a generally flat and flexible plastic or fabric strap 63 having a hooks portion 65 adjacent to a first end of the strap 63. A loops portion 67 is adjacent to an opposite, second end of the strap 63. Hook and loop fasteners, such as those sold under the trademark VELCRO, are well know in the prior art. The strap 63 may be wrapped around cables and said hooks portion 65 may be removably attached to said loops portion 67 to bundle the wrapped cables.

The plastic or fabric material forming the cable wrap 61 includes a material which exhibits color changes in response to temperature changes. The color changing material may be an additive to the plastic material or fabrics forming the cable wrap 61 and/or the color changing material may be formed as a layer over all of, or a portion of, the plastic or fabric material forming the cable wrap 61. Moreover, the cable wrap 61 may exhibit more than one color change to represent ranges of temperatures and may employ both a color changing material layer and a color changing material additive, as discussed above in conjunction with the cable jackets.

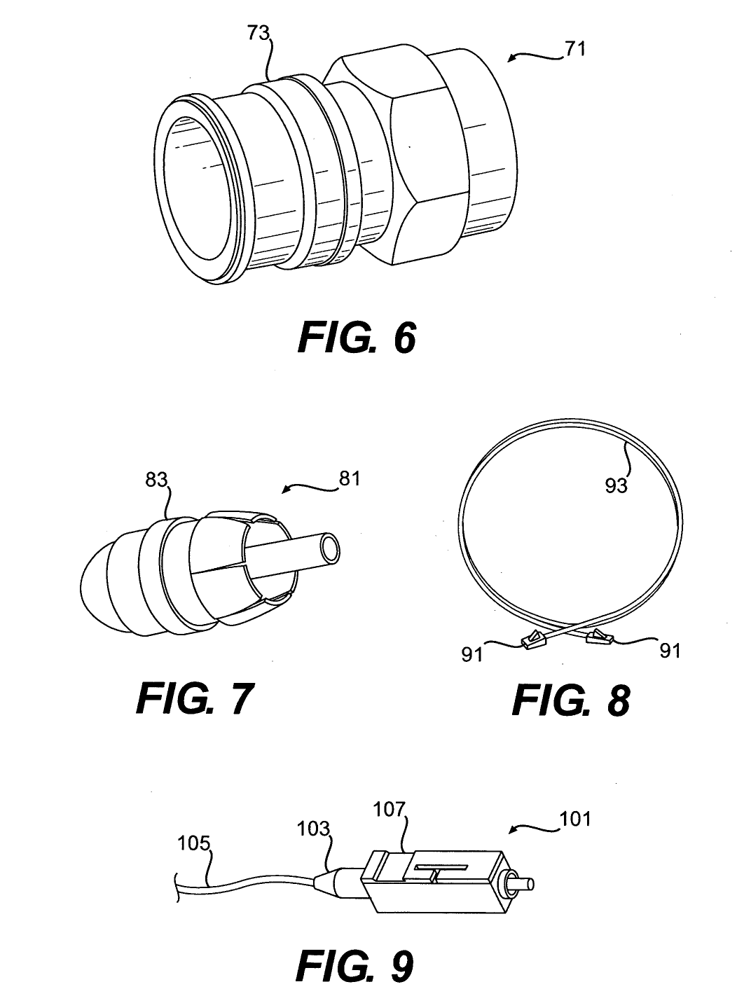

FIG. 6 illustrates a cable apparatus in the form of a coaxial connector 71. In FIG. 6, the coaxial connector 71 is in the form of an F-type connector which may be attached to a coaxial cable by a compression force. However, it should be appreciated that such a coaxial connector 71 could be a crimp style connector. The coaxial connector 71 includes a plastic ring 73 which encircles the conductive metal body of the coaxial connector 71. The plastic ring 73 is preferable seated in a groove or recess formed in the conductive metal body of the coaxial connector 71.

The plastic ring 73 includes a material which exhibits color changes in response to temperature changes. The color changing material may be an additive to the plastic material forming the plastic ring 73 and/or the color changing material may be formed as a layer over all of, or a portion of, the plastic ring 73. Moreover, the plastic ring 73 may exhibit more than one color change to represent ranges of temperatures and may employ both a color changing material layer and a color changing material additive, as discussed above in conjunction with the cable jackets.

FIG. 7 illustrates a cable apparatus in the form of another coaxial connector 81. In FIG. 7, the coaxial connector 81 is in the form of an RCA-type connector. However, it should be appreciated that other types of connectors may be employed, like BNC-type connectors, and mini connectors. The coaxial connector 81 also includes a plastic ring 83 which encircles the conductive metal body of the coaxial connector 81. The plastic ring 83 is preferable seated in a groove or recess formed in the conductive metal body of the coaxial connector 81.

The plastic ring 83 includes a material which exhibits color changes in response to temperature changes. The color changing material may be an additive to the plastic material forming the plastic ring 83 and/or the color changing material may be formed as a layer over all of, or a portion of, the plastic ring 83. Moreover, the plastic ring 83 may exhibit more than one color change to represent ranges of temperatures and may employ both a color changing material layer and a color changing material additive, as discussed above in conjunction with the cable jackets.

FIG. 8 illustrates a cable apparatus in the form of a twisted pair cable connector 91. In FIG. 8, the twisted pair cable connector 91 is in the form of an RJ-type connector, such as an RJ-45 or RJ-11 type plug, which is snapped onto a twisted pair cable 93 to form the illustrated patch cord. However, it should be appreciated that other types of plugs, such as the RJ-14, RJ-25 or RJ-61 type plug connectors may be employed. The twisted pair cable connector 91 is predominately formed of plastic.

The plastic of the twisted pair cable connector 91 includes a material which exhibits color changes in response to temperature changes. The color changing material may be an additive to the plastic material forming the twisted pair cable connector 91 and/or the color changing material may be formed as a layer over all of, or a portion of, the plastic forming the twisted pair cable connector 91. Moreover, the plastic forming the twisted pair cable connector 91 may exhibit more than one color change to represent ranges of temperatures and may employ both a color changing material layer and a color changing material additive, as discussed above in conjunction with the cable jackets.

FIG. 9 illustrates a cable apparatus in the form of a fiber optic connector 101. In FIG. 9, the fiber optic connector 101 is in the form of an SC-type connector, which includes a strain relief boot 103 to protect the connection of the fiber optic connector 101 to the fiber optic cable 105. However, it should be appreciated that other types of fiber optic connectors, such as LC-type and ST-type connectors, may be employed. A housing 107 of the fiber optic connector 101 is predominately formed of plastic.

The plastic of the housing 107 and/or the material forming the strain relief boot 103 includes a material which exhibits color changes in response to temperature changes. The color changing material may be an additive to the plastic material forming the housing 107/strain relief boot 103 and/or the color changing material may be formed as a layer over all of, or a portion of, the plastic forming the housing 107/strain relief boot 103. Moreover, the plastic forming the housing 107 may exhibit more than one color change to represent ranges of temperatures and may employ both a color changing material layer and a color changing material additive, as discussed above in conjunction with the cable jackets.

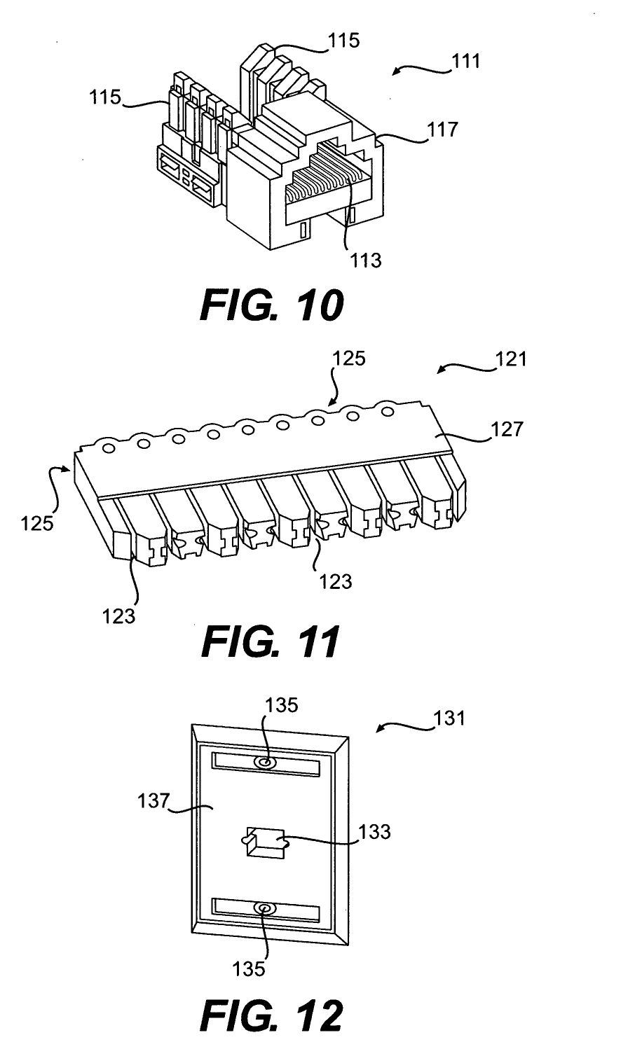

FIG. 10 illustrates a cable apparatus in the form of a twisted pair cable jack 111. In FIG. 10, the twisted pair cable jack 111 is in the form of an RJ-45 type jack, which includes a plurality of jack wires 113 which are electrically connected to insulation displacement contacts (IDCs) 115. However, it should be appreciated that other types of twisted pair cable jacks 111, such as RJ-11 types of jacks, may be employed. A housing 117 of the twisted pair cable jack 111 is predominately formed of plastic.

The plastic of the housing 117 includes a material which exhibits color changes in response to temperature changes. The color changing material may be an additive to the plastic material forming the housing 117 and/or the color changing material may be formed as a layer over all of, or a portion of, the plastic forming the housing 117. Moreover, the plastic forming the housing 117 may exhibit more than one color change to represent ranges of temperatures and may employ both a color changing material layer and a color changing material additive, as discussed above in conjunction with the cable jackets.

FIG. 11 illustrates a cable apparatus in the form of a connecting block 121. The connecting block 121 includes a plurality of insulation displacement contacts (IDCs) 123 on a first end and a plurality of jacks 125 on an opposite, second end in order to connect free wires to jacks. However, it should be appreciated that other types of connecting blocks may be employed, such as a connecting block having IDCs at both ends or a connecting block having jacks at both ends or a connecting block have IDCs at one end and a wiring block terminal strip at the opposite end. Connecting blocks 121 are typically inserted into rack mounted panels in a network closet. A housing 127 of the connecting block 121 is predominately formed of plastic.

The plastic of the housing 127 includes a material which exhibits color changes in response to temperature changes. The color changing material may be an additive to the plastic material forming the housing 127 and/or the color changing material may be formed as a layer over all of, or a portion of, the plastic forming the housing 127. Moreover, the plastic forming the housing 127 may exhibit more than one color change to represent ranges of temperatures and may employ both a color changing material layer and a color changing material additive, as discussed above in conjunction with the cable jackets.

FIG. 12 illustrates a cable apparatus in the form of a faceplate 131. The faceplate 131 includes a through hole 133 to frame a jack, such as jack 111, and a plurality of mounting holes 135 to accommodate fasteners, such as screws. The faceplate 131 is a general planar member 137 predominately formed of plastic.

The plastic of the planar member 137 includes a material which exhibits color changes in response to temperature changes. The color changing material may be an additive to the plastic material forming the planar member 137 and/or the color changing material may be formed as a layer over all of, or a portion of, the plastic forming the planar member 137. Moreover, the plastic forming the planar member 137 may exhibit more than one color change to represent ranges of temperatures and may employ both a color changing material layer and a color changing material additive, as discussed above in conjunction with the cable jackets.

In accordance with the present invention, cable apparatus, used in and around network closets and other locations, may include at least one component part formed of a color changing material. The color changing material may be in the form of an additive and/or an outer layer of the component part. The color change will be designed to occur before damage to the cable apparatus and/or any equipment in the vicinity. Therefore, the color change ability of the cable apparatus can be viewed as a tool of the technician in improving and adjusting the HVAC issues surrounding the cable apparatus and the equipment attached thereto. Also, the color change ability of the cable apparatus can be viewed as a tool of the technician to spot heat issues which could damage the cable apparatus and/or equipment attached thereto prior to suffering any actual damage.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A communication transmitting device comprising:
an optical fiber
a jacket at least partially surrounding said optical fiber, wherein said jacket is formed entirely or partially of a temperature sensitive material, wherein said temperature sensitive material changes visible color in response to a change in temperature from a first color to a second color, different from said first color.

2. The device of claim 1, wherein said jacket is formed of a polymer and wherein said temperature sensitive material is an additive to said polymer.

3. The device of claim 2, wherein said temperature sensitive material is also formed as an outer layer of at least a portion df said jacket.

4. The device of claim 1, wherein said temperature sensitive material is formed as an outer layer of at least a portion of said jacket.

5. The device of claim 1, wherein said temperature sensitive material assumes said first color at temperatures less than a first threshold temperature and assumes said second color at a temperature greater than said first threshold temperature.

6. The device of claim 5, wherein said first threshold temperature is about 90 degrees Fahrenheit.

7. The device of claim 5, wherein said temperature sensitive material assumes a third color, different than said first and second colors, at a temperature greater than a second threshold temperature, wherein said second threshold temperature is greater than said first threshold temperature.

8. The device of claim 7, wherein said first threshold temperature is about 75 degrees Fahrenheit and said second threshold temperature is about 90 degrees Fahrenheit.

9. The device of claim 1, wherein said second color is lighter in color than said first color and represents a higher temperature than said first color.

10-22. (canceled)

23. A communication connector device comprising:
a housing formed entirely or partially of a temperature sensitive material, wherein said temperature sensitive material changes visible color in response to a change in temperature from a first color to a second color, different from said first color.

24. The device of claim 23, wherein said housing is a connector housing for a terminal end of a communications cable.

25. The device of claim 24, wherein said connector housing constitutes an F-type coaxial connector.

26. The device of claim 24, wherein said connector housing constitutes an RJ-type connector for a twisted pair cable.

27. The device of claim 24, wherein said connector housing constitutes a fiber optic connector.

28. The device of claim 23, wherein said housing is a jack housing for receiving a connector of a communications cable.

29. The device of claim 28, wherein said jack housing constitutes a RJ-type jack.

30. The device of claim 23, wherein said housing is a connecting block having insulation displacement contacts.

31. The device of claim 23, wherein said housing is a faceplate for presenting a jack.

32. A device for wrapping around plural cables to form a bundle of cables comprising:
a flexible strap;
first fastening features proximate a first end of said strap; and
second fastening features proximate a second end of said strap, wherein said second fastening features are adapted to engage with said first fastening features when said device is wrapped around plural cables, and wherein at least a portion of said strap, first fastening features or second fastening features is formed of a temperature sensitive material, wherein said temperature sensitive material changes visible color in response to a change in temperature from a first color to a second color, different from said first color.

33. The device of claim 32, wherein said first fastening features include hooks proximate said first end of said strap and said second fastening features include loops proximate said second end of said strap, such that said strap may be wrapped around cables and said hooks may be removably attached to said loops to bundle the wrapped cables.

34. The device of claim 32, wherein said first fastening features include projections or grooves proximate said first end of said strap and said second fastening features include a cooperative locking structure proximate said second end of said strap, such that said strap may be wrapped around cables to bundle the wrapped cables.
